(19) United States
(12) Patent Application Publication
(10) Pub. No.: US 2020/0108689 A1
(43) Pub. Date: Apr. 9, 2020

(54) METHOD AND APPARATUS FOR SPLIT FLOW CHILLER

(71) Applicant: GM GLOBAL TECHNOLOGY OPERATIONS LLC, Detroit, MI (US)

(72) Inventors: Rolf B. Karlsson, Grand Blanc, MI (US); Jeffrey A. Bozeman, Rochester, MI (US)

(21) Appl. No.: 16/150,844

(22) Filed: Oct. 3, 2018

(51) Int. Cl. B60H 1/00; B60L 11/18

(52) U.S. Cl. CPC B60H 1/00278; B60H 1/004; B60H 1/00392; B60L 2240/34; B60H 1/00885; B60H 2001/00307; B60L 2240/36; B60L 11/1874

(57) ABSTRACT

A method and apparatus for vehicle cabin cooling for automobile applications. Specifically, an apparatus and method for generating a cold temperature coolant using a split flow chiller having a first low flow portion surrounding a first portion of a refrigerant loop for coupling to a cabin cooler. The split flow chiller has a second high flow portion surrounding a second portion of the refrigeration loop for generating a cool temperature coolant for coupling to a battery cooler.

### TECHNICAL FIELD

The present invention generally relates to a vehicular cooling system and, more particularly, to a combination chiller bypass system suitable for cooling the A/C module and battery pack of an electric or hybrid vehicle.

### BACKGROUND

Vehicles are routinely equipped with an air conditioning (A/C) chiller system, which circulates a liquid coolant through the A/C cooler of an air conditioning module (e.g., a heating, ventilation, and air conditioning module) to maintain the A/C cooler below a desired temperature (e.g., 5 degrees Celsius). A representative A/C module chiller system includes a chiller, a recirculation pump, and a series of flow passages fluidly coupling the components of the A/C module chiller system to the A/C cooler. When energized, the pump circulates a liquid coolant (e.g., ethylene glycol) between the chiller and the A/C cooler. The coolant conductively transfers heat from A/C cooler to the chiller thus cooling the A/C cooler and heating the chiller. The chiller is, in turn, cooled by a refrigeration assembly.

In addition to the A/C module chiller system, hybrid and electric vehicles may be further equipped with a secondary chiller system (the “battery pack chiller system”) suitable for cooling the battery pack utilized to power the vehicle's electric motor/generator. As does the A/C chiller system, the battery pack chiller system includes a chiller, a recirculation pump, and a series of flow passages fluidly coupling the components of A/C chiller system to the vehicle's battery pack. During operation, the battery pack chiller system circulates a liquid coolant (e.g., ethylene glycol) between the vehicle's battery pack and the chiller. The liquid coolant conductively transfers heat from the battery pack to the chiller. This results in the cooling of the battery pack and the heating of the chiller, which is subsequently cooled by a refrigeration assembly as described above. By cooling the battery pack in this manner, the battery pack chiller system may maintain the battery pack at or near a desired operating temperature, such as 25 degrees Celsius, thus optimizing the battery pack's operational life and performance. Notably, the desired operating temperature of the battery pack is typically considerably higher than the desired operating temperature of the A/C cooler.

Dual chiller cooling infrastructures of the type described above (i.e., infrastructures employing both an A/C chiller system and a separate battery pack chiller system) are capable of adequately cooling a vehicle's A/C module and battery pack; however such dual chiller infrastructures are limited in certain respects. In particular, such dual chiller cooling infrastructures tend to be relatively bulky, weighty, and costly as each chiller system generally requires its own chiller, recirculation pump, plumbing, and other such components.

Accordingly, it is desirable to provide a chiller bypass system suitable for cooling both the A/C module and the battery pack of a vehicle utilizing a single chiller. Preferably, such a chiller bypass system would permit independent regulation of the temperature of the A/C module and the temperature of the battery pack. It would also be desirable to provide a method for operating such a chiller bypass system. Other desirable features and characteristics of the present invention will become apparent from the subsequent detailed description and the appended claims, taken in conjunction with the accompanying drawings and the foregoing technical field and background.

### SUMMARY

Embodiments according to the present disclosure provide a number of advantages. For example, embodiments according to the present disclosure may enable improved performance of hybrid vehicle battery cooling systems and vehicle cabin climate control systems.

The present disclosure describes a vehicle cooling system comprising a cabin cooler, a battery cooler, a chiller having a first passage and a second passage, an inlet for receiving a coolant from the battery cooler and coupling the coolant to a first passage and a second passage, a refrigerant loop having a first portion within the first passage and a second portion within the second passage, a first outlet for coupling the coolant from the first passage to the cabin cooler, and a second outlet for coupling the coolant from the second passage to the battery cooler.

Another aspect of the present disclosure describes an apparatus comprising a coolant reservoir having a first coolant passage and a second coolant passage, a cabin cooler coupled to the first coolant passage, a battery cooler coupled to the second coolant passage, an inlet for coupling a coolant from the battery cooler to the first coolant passage and the second coolant passage, and a refrigerant coil having a first portion within the first coolant passage and a second portion within the second coolant passage wherein a refrigerant within the first portion has a lower temperature than a refrigerant within the second portion.

Another aspect of the present disclosure describes a method comprising receiving a high temperature fluid from a battery cooler, coupling a first portion of the high temperature fluid into a low flow fluid passage, coupling a second portion of the high temperature fluid into a high flow fluid passage, passing the first portion of the high temperature fluid within the low flow fluid passage through a first portion of a refrigeration loop to generate a first low temperature fluid, passing the second portion of the high temperature fluid within the high flow fluid passage through a second portion of a refrigeration loop to generate a second low temperature fluid, coupling the first low temperature fluid to a cabin cooler, and coupling the second low temperature fluid to the battery cooler.

Additional features of the present invention will become apparent from the following description and appended claims, taken in conjunction with the accompanying drawings.

### BRIEF DESCRIPTION OF THE DRAWINGS

The present invention will hereinafter be described in conjunction with the following drawing figures, wherein like numerals denote like elements, and:

FIG. 1 shows a block diagram of an exemplary application for a split flow chiller for automobile applications according to the present disclosure.

FIG. 2 shows a chiller configuration for vehicle applications according to an exemplary embodiment of the present disclosure.

FIG. 3 shows a method of cabin and battery cooling for vehicle applications according to an exemplary embodiment of the present disclosure.

FIG. 4 shows an alternate chiller configuration for vehicle applications according to an exemplary embodiment of the present disclosure

### DETAILED DESCRIPTION OF THE EMBODIMENTS

The following discussion of the embodiments of the invention directed to a vehicle coolant system is merely exemplary in nature, and is in no way intended to limit the invention or its applications or uses. For example, the cooling system of the present disclosure is described as having application for a vehicle. However, as will be appreciated by those skilled in the art, the architecture may have applications other than automotive applications.

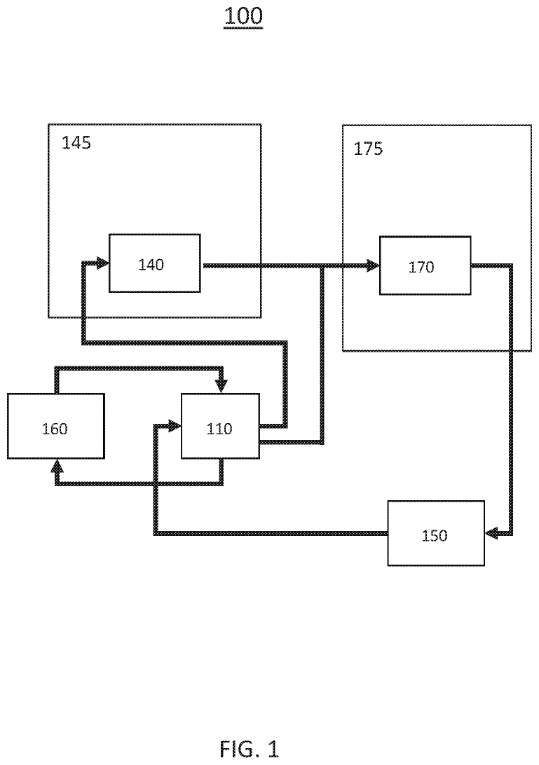

Turning now to FIG. 1, a block diagram of an exemplary application for a split flow chiller for automobile applications 100 according to the present disclosure is shown. The system has a chiller 110 according to an exemplary embodiment of the present disclosure. According to this exemplary embodiment, the chiller 110 is a heat transfer device used to remove heat from a coolant used to cool a battery assembly 175 via a battery cooler 170 and a vehicle cabin 145 via a cooling core 140. The coolant is then returned to the chiller 110 via a coolant reservoir 150. The chiller is operative to receive a refrigerant from a refrigeration assembly 160.

The refrigeration assembly 160 may comprise any device or system suitable for continually conducting a cooled refrigerant through a chiller flow passage to conductively cool the chiller 110. By way of example, refrigeration assembly 160 may be a single-stage vapor compression refrigeration system that includes a compressor, a condenser, and a throttle valve. A plurality of conduits join the compressor, condenser, and throttle valve in flow series. The refrigeration assembly 160 may also include additional components that are conventionally known, such as various pressure and temperature sensors.

During operation, refrigeration assembly 160 continually supplies the inlet of the exemplary chiller 110 with a cooled and partially vaporized refrigerant. As it flows through chiller 110, the refrigerant further vaporizes and conductively absorbs heat from the body of chiller 110. By absorbing heat in this manner, the refrigerant cools the chiller 110 and, therefore, the coolant flowing through chiller flow passages. The heated vaporized refrigerant then flows out of the chiller, through a conduit, and back into the refrigeration assembly. The compressor may use a mechanical piston or other such means to compress, and thus superheat, the vaporized refrigerant. The superheated vaporized refrigerant then flows into the condenser, which causes the refrigerant to return to its liquid state. As the vaporized refrigerant changes phase to liquid, heat is released. This heat is dissipated by convectively cooling the condenser utilizing an external cooling fluid, such as ambient air. Now in a liquid state, the cooled refrigerant flows into throttle valve wherein an abrupt decrease in pressure causes the refrigerant to partially vaporize. The refrigeration assembly 160 then directs the cooled and partially vaporized refrigerant back to the inlet of chiller 110, and the process is repeated.

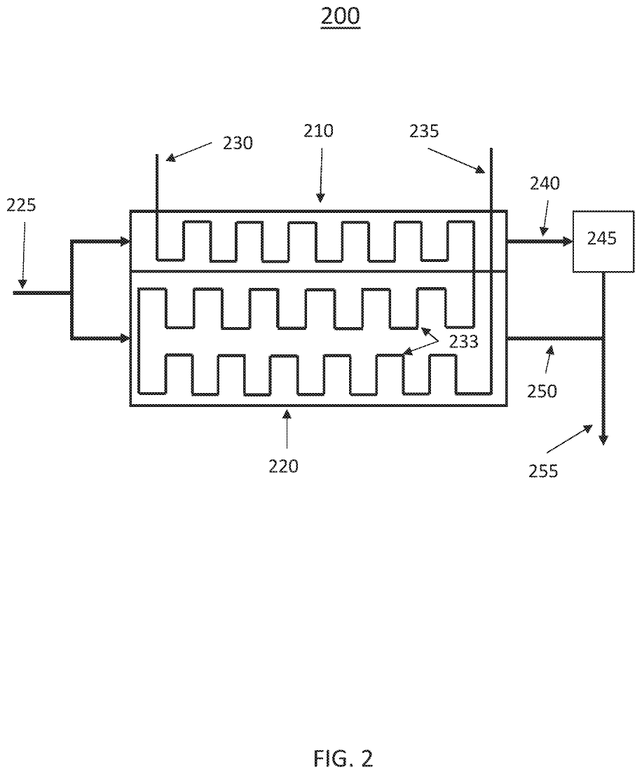

According to an exemplary embodiment of the present disclosure, the chiller 110 has a selectable first outlet to supply low temperature coolant to the cooling core 140 and a second outlet for supplying low temperature coolant to the battery cooler 170. The first outlet may be selected when the cooling of the vehicle cabin 145 is desired. The chiller 110 configuration will be explained in greater detail in the description of FIG. 2.

Turning now to FIG. 2, a chiller configuration for vehicle applications 200 according to an exemplary embodiment of the present disclosure is shown. The exemplary chiller has a first coolant passage 210 and a second coolant passage 220. The first coolant passage 210 is a low flow chiller passage and the second coolant passage 220 is a high flow chiller passage. The first chiller passage 210 and the second chiller passage 220 receive heated coolant from the battery pack and/or reservoir via a chiller inlet 225, wherein the coolant temperature is reduced through contact with the refrigerant loop. The second coolant passage 220 then couples chilled coolant via a second coolant passage outlet 250 to the battery cooler. The first coolant passage couples chilled coolant via a first coolant passage outlet 240 to the cabin cooling core 245 and then to the battery cooler. The coolant is coupled to the refrigerant loop 233 via the refrigerant input 230 and returned to the refrigeration system via the refrigeration outlet 235.

The novel chiller configuration 200 is operative to split the coolant through the chiller into a low flow/low temp side first coolant passage 210 and a high flow/higher temp second coolant passage 220. The cabin cooling core 245 is supplied from the low flow first coolant passage 210 before combining the flows feeding the battery cooler. Flow split may be controlled with one or more orifices or valve. The refrigerant inlet supplies the low flow first coolant passage 210 first to maintain lowest temperatures. In addition, the cabin cooling core may function as low temperature radiator, providing a low energy cost air-to-water cooling function for the battery when HVAC system is disengaged and the refrigeration circuit is disengaged from the chiller.

The presently disclosed system may be particularly useful where a smaller remote coolant and heating system are desired, such in a three row seating hybrid vehicle with refrigerant-to-coolant RESS battery cooling. The exemplary system may advantageously replace a rear evaporator with a small coolant heat exchanger. This may be accomplished by partitioning the coolant flow through the chiller with the smaller passage on the refrigerant inlet side. A target flow-rate and chiller water exit temperature for the low flow partition are selected based on max desired heat transfer for rear cabin cooling function. Optionally the total chiller capacity may be increased to meet maximum cabin and battery cooling. A coolant flow-restriction orifice, two mechanically variable orifices, or a coolant flow control valve may be selected as a mechanism to maintain the desired flow split between chiller partitions.

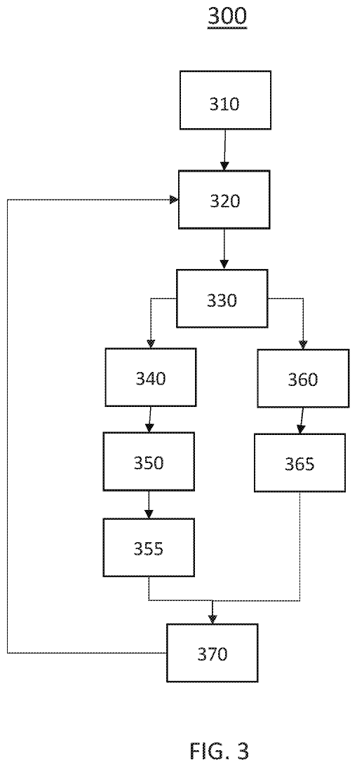

Turning now to FIG. 3, a method of cabin and battery cooling for vehicle applications 300 according to an exemplary embodiment of the present disclosure is shown. The method is first operative to generate a refrigerant loop 310 wherein the refrigerant loop flows through a first portion of an evaporator coil within a first chiller passage, and then flows through a second portion of the evaporator coil within a second chiller passage. The flow of the refrigerant loop may be controlled in response to a vehicle battery pack temperature, a cabin temperature, a control signal generated by a vehicle occupant, a vehicle load level, or any combination thereof. The refrigerant within first portion of the evaporator coil will have a lower temperature than the refrigerant within the second portion of the evaporator coil. Thus, the first portion of the evaporator coil with be more effective at removing heat from any liquid surrounding the first portion. As the refrigerant flows through the second portion of the evaporator coil, the refrigerant temperature will be slightly higher and therefore the second portion of the evaporator coil with be less effective at removing heat from any liquid surrounding the second portion of the evaporator coil.

The method is next operative to receive a flow of heated liquid coolant from the battery pack 320. The method is then operative to split the flow of heated liquid coolant into a first channel and a second channel 330 wherein the first channel is coupled to the first chiller passage and the second channel is coupled to the second chiller passage. The heated liquid coolant routed into the first chiller passage then flows around the first portion of the evaporator coil 340. Heat is extracted from the liquid coolant within the first chiller passage as the liquid contacts the first portion of the evaporator coil 350 to generate a first flow of cooled liquid coolant. The method is then operative to couple this first flow of cooled liquid coolant to a cabin cooler 355. The liquid coolant routed to the second chiller passage then flows around the second portion of the evaporator coil 360. Heat is extracted from the liquid coolant within the second chiller passage as the liquid contacts the second portion of the evaporator coil 365 to generate a second flow of cooled liquid coolant. The second flow of cooled liquid coolant is combined with the liquid coolant flow from the cabin cooler and coupled to the battery cooler 370. Heat is extracted from the vehicle battery by the liquid coolant flowing through the battery cooler. The resulting heated liquid coolant is the returned to the first and second channels for heat extraction 320.

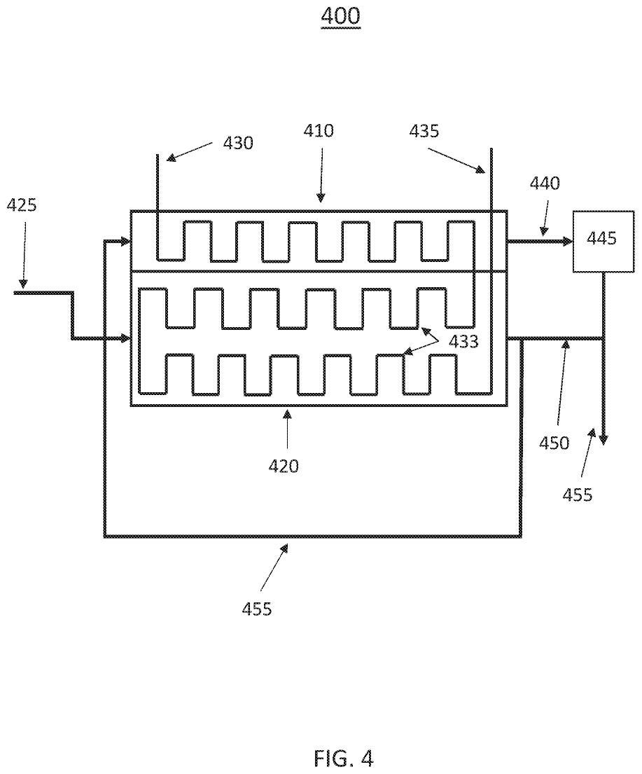

Turning now to FIG. 4, an alternate chiller configuration for vehicle applications 400 according to an exemplary embodiment of the present disclosure is shown. The exemplary chiller has a first coolant passage 410 and a second coolant passage 420. The first coolant passage 410 is a low flow chiller passage and the second coolant passage 420 is a high flow chiller passage. The second chiller passage 420 is configured to receive heated coolant from the battery pack and/or reservoir via a chiller inlet 425, wherein the coolant temperature is reduced through contact with the refrigerant loop 433. The second coolant passage 420 is configured to couple the chilled coolant via a second coolant passage outlet 450 to the battery cooler. In addition, the second coolant passage 420 is configured to couple a portion of the chilled coolant via a feedback branch 455 to the inlet of the first coolant passage 410. The first coolant passage 410 couples chilled coolant via a first coolant passage outlet 440 to the cabin cooling core 445 and then to the battery cooler. The coolant is coupled to the refrigerant loop 433 via the refrigerant input 430 and returned to the refrigeration system via the refrigeration outlet 435.

The novel chiller configuration 400 is operative to received partially cooled coolant from the second coolant passage 420 into a low flow/low temp side first coolant passage 410. The cabin cooling core 445 is supplied from the low flow first coolant passage 410 before combining the flows feeding the battery cooler. Flow split at the outlet of the second coolant passage 420 may be regulated with a balancing orifice between the feedback branch 455 and the battery cooler. The low flow first coolant passage 410 is fed from the outlet of the high flow second coolant passage 420 in a partial series arrangement which may advantageously yield colder coolant flow through the cabin cooling core 445 with an increase in total system pressure drop, or lower coolant flow, through the battery cooler.

It should be emphasized that many variations and modifications may be made to the herein-described embodiments, the elements of which are to be understood as being among other acceptable examples. All such modifications and variations are intended to be included herein within the scope of this disclosure and protested by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could” “might,” “may” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle cooling system comprising:
a cabin cooler;
a battery cooler;
a chiller having a first passage and a second passage;
an inlet for receiving a coolant from the battery cooler and coupling the coolant to a first passage and a second passage;
a refrigerant loop having a first portion within the first passage and a second portion within the second passage:
a first outlet for coupling the coolant from the first passage to the cabin cooler; and
a second outlet for coupling the coolant from the second passage to the battery cooler.

2. The vehicle cooling system of claim 1 wherein an outlet of the cabin cooler is coupled to an inlet of the battery cooler such that the coolant flows in series through the cabin cooler and the battery cooler.

3. The vehicle cooling system of claim 1 wherein the refrigerant loop is an evaporator.

4. The vehicle cooling system of claim 1 a refrigerant flowing within the refrigerant loop has a lower temperature within the first portion and a higher temperature within the second portion.

5. The vehicle cooling system of claim 1 further comprising a valve coupled to the first passage for preventing coolant flow into the first passage.

6. The vehicle cooling system of claim 1 wherein the first passage has a lower coolant flow and the second passage has a higher coolant flow.

7. The vehicle cooling system of claim 1 wherein the vehicle is an electric vehicle having a rechargeable battery.

8. The vehicle cooling system of claim 1 wherein the cabin cooler is located proximate to a rear seat in a vehicle.

9. An apparatus comprising:
a coolant reservoir having a first coolant passage and a second coolant passage;
a cabin cooler coupled to the first coolant passage;
a battery cooler coupled to the second coolant passage;
an inlet of the second coolant passage for coupling a coolant from the battery cooler to the second coolant passage;
a feedback branch for coupling the coolant from an outlet of the second coolant passage to an inlet of the first coolant passage;
a refrigerant coil having a first portion within the first coolant passage and a second portion within the second coolant passage wherein a refrigerant within the first portion has a lower temperature than a refrigerant within the second portion.

10. The apparatus of claim 9 further comprising a pump for circulating the refrigerant within the refrigerant coil.

11. The apparatus of claim 9 wherein the first portion is in series with the second portion.

12. The apparatus of claim 9 wherein a coolant flows within the first coolant passage and the second coolant passage.

13. The apparatus of claim 9 wherein the coolant reservoir is operative to remove heat from a coolant.

14. The apparatus of claim 9 wherein the cabin cooler is operative to receive a low temperature coolant from the first passage and wherein the low temperature coolant is used to cool a vehicle cabin.

15. The apparatus of claim 9 further comprising a valve for restricting flow of a coolant into the first passage in response to a vehicle cabin temperature setting.

16. A method comprising:
receiving a high temperature fluid from a battery cooler;
coupling a first portion of the high temperature fluid into a low flow fluid passage;
coupling a second portion of the high temperature fluid into a high flow fluid passage;
passing the first portion of the high temperature fluid within the low flow fluid passage through a first portion of a refrigeration loop to generate a first low temperature fluid;
passing the second portion of the high temperature fluid within the high flow fluid passage through a second portion of a refrigeration loop to generate a second low temperature fluid;
coupling the first low temperature fluid to a cabin cooler; and
coupling the second low temperature fluid to the battery cooler.

17. The method of claim 16 wherein the first low temperature fluid is colder than the second low temperature fluid.

18. The method of claim 16 wherein high temperature fluid is a coolant for cooling a rechargeable battery pack.

19. The method of claim 16 wherein the first low temperature fluid is coupled to the cabin cooler in response to a vehicle cabin temperature.

20. The method of claim 16 wherein an output of the cabin cooler is coupled to an input of the battery cooler.
